(19) United States
(12) Patent Application Publication
(10) Pub. No.: US 2021/0209603 A1
(43) Pub. Date: Jul. 8, 2021

(54) METHOD FOR PREVENTING FRAUD IN TRUSTED NETWORK, AND SYSTEM THEREOF

(71) Applicant: Wipro Limited, Bangalore (IN)

(72) Inventors: Vinod Ramachandra Panicker, Kochi (IN); Sumod Rajan George, Ernakulam (IN)

(21) Appl. No.: 16/800,141

(22) Filed: Feb. 25, 2020

(30) Foreign Application Priority Data
Jan. 8, 2020 (IN) 202041000765

(51) Int. Cl. G06Q 20/40; G06Q 10/10; G06Q 30/00; G06F 16/23; H04L 29/06

(52) U.S. Cl. CPC G06Q 20/4016; G06Q 10/10; G06Q 2220/00; G06F 16/2379; H04L 63/0428; G06Q 30/018

(57) ABSTRACT

The present disclosure relates to a method for preventing fraud in a trusted network. An information related to a plurality of fraudulent transactions are received from a plurality of entities in the trusted network. Each of the plurality of entities provides a consent for sharing the information related to corresponding plurality of fraudulent transactions. Indicators of Fraudulent Transactions (IOFT) metadata are generated based on one or more patterns in the information related to the plurality of fraudulent transactions. One or more IOFT data elements comprising transaction details associated with the plurality of fraudulent transactions and excluding confidential details are identified from the IOFT metadata. One or more IOFT data elements are transmitted in an encrypted format to the plurality of entities over the trusted network to prevent the fraud in the trusted network.

### TECHNICAL FIELD

The present disclosure relates to computer networks. More particularly, the present disclosure relates to a method and system for preventing fraud over a trusted network.

### BACKGROUND

Organizations are connected over computer networks (especially over the Internet) as computing capability is evolving rapidly. The number of computers connected to the network is growing exponentially. The greater usage of computer networks has resulted in the network being prone to security threats. Computer network has become a medium for criminal activities including fraud and identity theft as the computer networks are generally connected to the Internet. Devices connected to the computer network comprises of mobile devices, Personal Digital Assistants (PDA), laptops or any other electronic devices connected to the Internet. The devices provide a user with a set of options in the form of mobile applications for performing the financial or data transactions with ease and comfort.

Technological advancements has motivated fraudsters to come up with mechanisms to perform fraudulent transactions affecting business entities and the users, resulting in huge loss of data and/or money. Although, individual entities connected in a network take precautions to avoid intrusion, the entities are prone to attacks via the connected network as other entities are not equally equipped to prevent intrusion. Further, an entity affected by an intrusion does not share data related to the fraudulent transactions due to various reasons including but not limited to, prevent publicity of such attacks, avoid sharing confidential information and the like. The retention of information related to the attacks further motivates the fraudsters to perform such frauds with other entities connected in the network. Conventionally, when an entity detects a fraud, then such a customer is blacklisted for further communications with the entity. However, conventionally, there is no mechanism to detect if the backlisted customer information is updated across all the entities. Additionally, lack of collaboration between the entities also makes it difficult to ensure that similar fraudulent transactions are not replicated across the plurality of entities.

One of the major challenges while sharing data related to the fraudulent transactions is that the data may comprise of personal information, and other information for which consent may be required from the data owner before such data is being shared across the entities. Further, the legal data sharing regulations add on to the problem. Thus, existing solutions do not provide a mechanism on ability of an entity or enterprise to determine if the information can be shared with others without compromising on private information in a secure manner. Also, consent of various stakeholders is not taken into account before sharing of information.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a method for preventing fraud in a trusted network. The method comprises, receiving, by a computing system, information related to a plurality of fraudulent transactions from each of a plurality of entities in the trusted network. Each of the plurality of entities provides a consent for sharing the information related to corresponding plurality of fraudulent transactions. Further, the method comprises generating Indicators of Fraudulent Transactions (IOFT) metadata based on one or more patterns in the information related to the plurality of fraudulent transactions. Furthermore, the method comprises, identifying one or more IOFT data elements from the IOFT metadata. The one or more IOFT data elements comprises transaction details associated with the plurality of fraudulent transactions and excludes confidential details. Thereafter, the method comprises, transmitting one or more IOFT data elements in an encrypted format to the plurality of entities over the trusted network to prevent the fraud in the trusted network.

In an embodiment, the present disclosure discloses a computing system for preventing fraud in a trusted network. The computing system comprising a processor and a memory. The processor is configured to receive information related to a plurality of fraudulent transactions from each of a plurality of entities in the trusted network. Each of the plurality of entities provides a consent for sharing the information related to corresponding plurality of fraudulent transactions. Further, the processor generates Indicators of Fraudulent Transactions (IOFT) metadata based on one or more patterns in the information related to the plurality of fraudulent transactions. Furthermore, the processor identifies one or more IOFT data elements from the IOFT metadata. The one or more IOFT data elements comprise transaction details associated with the plurality of fraudulent transactions and excludes confidential details. Thereafter, the processor transmits the one or more IOFT data elements in an encrypted format to the plurality of entities over the trusted network to prevent the fraud in the trusted network.

In an embodiment, the present disclosure discloses a non-transitory computer readable medium including instructions stored thereon that when processed by at least one processor cause a computing system to prevent fraud in a trusted network. The processor is configured to receive information related to a plurality of fraudulent transactions from each of a plurality of entities in the trusted network. Each of the plurality of entities provides a consent for sharing the information related to corresponding plurality of fraudulent transactions. Further, the processor generates Indicators of Fraudulent Transactions (IOFT) metadata based on one or more patterns in the information related to the plurality of fraudulent transactions. Furthermore; the processor identifies one or more IOFT data elements from the IOFT metadata. The one or more IOFT data elements comprise transaction details associated with the plurality of fraudulent transactions and excludes confidential details. Thereafter, the processor transmits the one or more IOFT data elements in an encrypted format to the plurality of entities over the trusted network to prevent the fraud in the trusted network.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristic of the disclosure are set forth in the appended claims. The disclosure itself, however, as well as a preferred mode of use, further objectives and advantages thereof will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 shows an exemplary environment illustrating plurality of entities forming a trusted network, in accordance with some embodiments of the present disclosure;

FIG. 2 shows an exemplary block diagram illustrating roles of the plurality of entities in the trusted network, in accordance with some embodiments of the present disclosure;

FIG. 3 shows an internal architecture of a computing system for preventing fraud in the trusted network, in accordance with some embodiments of the present disclosure;

FIG. 4 shows an exemplary flow chart illustrating method steps for preventing the fraud in the trusted network, in accordance with some embodiments of the present disclosure;

FIG. 5 shows an exemplary environment illustrating prevention of the fraud between the plurality of entities connected in the network, in accordance with embodiments of the present disclosure; and

FIG. 6 shows a block diagram of a general-purpose computing system for preventing the fraud in the trusted network, in accordance with embodiments of the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes, which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Existing systems relate to presenting fraud detection information. However, the existing systems do not provide a mechanism for generating and sharing Indicators Of Fraudulent Transactions (IOFTs) between multiple entities.

Embodiments of the present disclosure relate to a method and a system to prevent fraud in a trusted network. Information related to a plurality of fraudulent transactions is received from each of a plurality of entities in the trusted network. Each of the plurality of entities provides a consent for sharing the information related to corresponding plurality of fraudulent transactions. Indicators of Fraudulent Transactions (IOFT) metadata are generated based on one or more patterns in the information related to the plurality of fraudulent transactions and one or more IOFT data elements are identified from the IOFT metadata. The one or more IOFT data elements comprise transaction details associated with the plurality of fraudulent transactions and excludes confidential details. The one or more IOFT data elements are transmitted in an encrypted format to the plurality of entities over the trusted network to prevent the fraud in the trusted network.

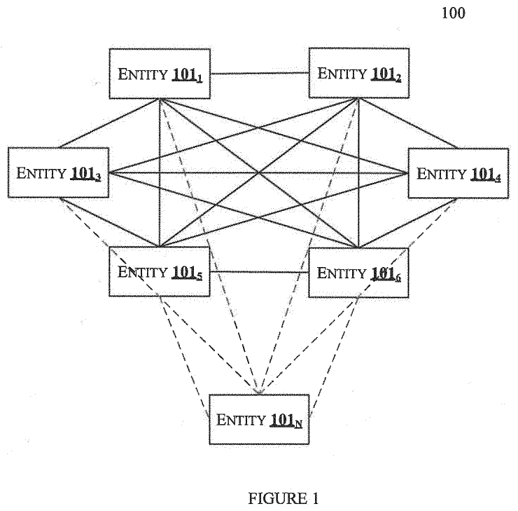

FIG. 1 illustrates a trusted network (100) formed by a plurality of entities (101₁, 101₂, . . . , 101_{N}). The trusted network may be a network of decentralized nodes. In an embodiment, the trusted network may implement a blockchain architecture to increase the security of the trusted network. The trusted network may permit an entity to be part of the network through validation. An entity may be permitted into the trusted network when rest of the existing entities of the trusted network provide approval. In an exemplary embodiment, the plurality of entities (101₁, 101₂, . . . , 101_{N}) may be connected to the trusted network over a peer-to-peer communication channel. The plurality of entities (101₁, 101₂, . . . , 101_{N}) may be a bank, an insurance company, an e-commerce merchant, customers associated with the bank, insurance company or any other entity which may be subjected to plurality of fraudulent transactions. The plurality of fraudulent transactions may comprise any kind of data transaction.

A person having ordinary skill in the art will appreciate that the scope of the disclosure is not limited to the aforementioned entities. In an embodiment, the term entity described herein encompasses all institutions/organizations that are related to transaction processing. Further, a person having ordinary skill in the art will appreciate that the scope of the term “transaction” is not limited to merely to the aforementioned entities. The term “transaction” encompasses any kind of exchange of information carried out between two parties for a particular purpose. For example, in an e-commerce environment, the transaction may correspond to a shopping transaction and may include personal and confidential information of the consumer. In another example, within a healthcare industry a transaction may correspond to medical reports associated with a patient.

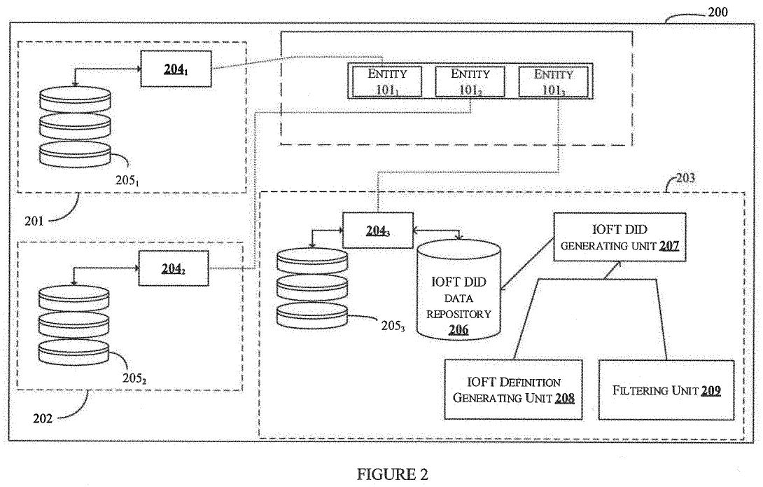

FIG. 2 shows exemplary block diagram (200) illustrating roles of the plurality of entities. Each entity in the trusted network (100) can act as at least one of an issuing entity (201), a verifying entity (202), and a holding entity (203). The issuing entity (201), the verifying entity (202) and the holding entity (203) are together configured to generate the IOFTs and thereby prevent fraudulent transactions in the trusted network (100).

In an embodiment, the issuing entity (201) refers to an entity among the plurality of entities (101₁, 101₂, . . . , 101_{N}) authorized to share proofs to other entities in the trusted network (100). The proofs may include, but are not limited to, confirmation about eligibility of an entity to offer certain kind of services, confirmation on eligibility of an entity's ownership on information and the like.

In an embodiment, the holding entity (203) may hold the information related to the plurality of fraudulent transactions. Further, the holding entity (203) may request for the proof from the issuing entity (201) before sharing the information related to the plurality of fraudulent transactions with the plurality of entities (101₁, 101₂, . . . , 101_{N}). Further, the holding entity (203) may share the proof with other entities to establish ownership. The holding entity (203) may store information related to one or more blacklisted entities and may also receive information related to other blacklisted entities from the issuing entity (201). The information related to the one or more blacklisted entities and the other blacklisted entities may be used for generating the IOFT Decentralized Identifier (DID). In an embodiment, the holding entity (203) may include a node (2043), a block-chain ledger (2053), an IOFT DID data repository (206), an IOFT DID Generating Unit (207), a Filtering Unit (209), and an IOFT Definition Unit (208).

The verifying entity (202) verifies the proof shared by the holding entity (203) and confirms the authenticity of the proof. Further, after verifying the proof, all participants in the network (100) may access the proof shared by the holding entity (203). Further, each of the plurality of entities (101₁, 101₂, . . . , 101_{N}) in the trusted network (100) includes the node (204ᵢ) for connecting with the trusted network (100) and a local copy of the block-chain ledger (205ᵢ), where i denotes corresponding participant or entity in the trusted network (100). In an embodiment, the node (204ᵢ) may be a computing device capable of creating, receiving or transmitting information over a network. In an embodiment, the block-chain ledger (205ᵢ) may refer to records maintained by the trusted network (100).

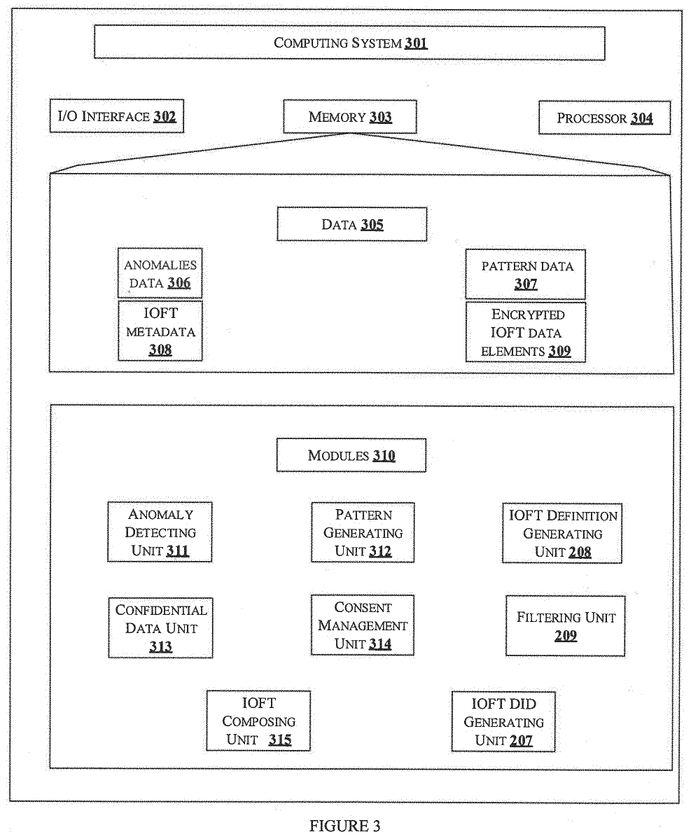

FIG. 3 illustrates internal architecture of the computing system (301) in accordance with some embodiments of the present disclosure. The computing system (301) may include at least one Central Processing Unit (“CPU” or “processor”) (304) and a memory (303) storing instructions executable by the at least one processor (304). The processor (304) may comprise at least one data processor for executing program components for executing user or system-generated requests. The memory (303) is communicatively coupled to the processor (304). The computing system (301) further comprises an Input/Output (I/O) interface (302). The I/O interface (302) is coupled with the processor (304) through which an input signal or/and an output signal is communicated.

In an embodiment, data (305) may be stored within the memory (303). The data (305) may include, for example, anomalies data (306), pattern data (307), IOFT metadata (308), encrypted IOFT data elements (309) and other data (not shown in figure).

In an embodiment, the anomalies data (306) may refer to information related to flagged fraudulent transactions obtained from an anomaly detecting unit (311). The anomalies data may comprise data, which differs significantly from majority of data. The anomalies data (306) may be received as input by the computing system (301) to generate IOFT data elements. The anomalies data (306) may refer to information specific to a corresponding entity (101₁, 101₂, . . . , 101_{N}) which is not intended to be shared with other entities.

In an embodiment, pattern data (307) may refer to grouping of the plurality of fraudulent transactions based on the one or more patterns. The one or more patterns may include, but are not limited to, frequency of transactions from a specific Internet Protocol (IP) within an IP range, frequency of transactions based on modes of transactions, specific information of the plurality of entities (101₁, 101₂, . . . , 101_{N}), private data elements or the like. In an embodiment, the mode of transactions may refer to physical transactions such as cash, or transaction using Internet by plurality of entities (101₁, 101₂, . . . , 101_{N}). For example, for a retailer, the pattern may be fraudulent transactions are caused for users using a specific brand of credit card. Hence, it is necessary to identify the pattern and blacklist the brand of credit card to avoid future frauds. Likewise, a bank may notice that transactions happening in a specific store are fraudulent and may blacklist the store.

In an embodiment, the IOFT metadata (308) may include, but are not limited to, one of an Internet Protocol (IP), Media Access Control (MAC) address, Uniform Resource Locator (URL) associated with each of the plurality of transactions, data feed elements from one or more applications used for a plurality of transactions associated with the plurality of entities (101₁, 101₂, . . . , 101_{N}) and mode of transactions.

In an embodiment, the encrypted IOFT data elements (309) refers to IOFT metadata that is converted to an encrypted format using private key encryption.

In an embodiment, the other data may refer to data from local databases or any other data required by the computing system (301) for performing the method.

In an embodiment, the data (305) in the memory (303) may be processed by modules (310) of the system. As used herein, the term module refers to an Application Specific Integrated Circuit (ASIC), an electronic circuit, a Field-Programmable Gate Arrays (FPGA), Programmable System-on-Chi (PSoC), a combinational logic circuit, and/or other suitable components that provide the described functionality. The modules (310) when configured with the functionality defined in the present disclosure will result in a novel hardware.

In one implementation, the modules (310) may include, for example, the anomaly detecting unit (311), a pattern generating unit (312), an IOFT definition generating unit (208), a confidential data unit (313), a consent management unit (314), a filtering unit (209), an IOFT composing unit (315), an IOFT DID generating unit (207) and other modules. It will be appreciated that such aforementioned modules (209) may be represented as a single module or a combination of different modules.

In an embodiment, the anomaly detecting unit (311) may be configured to extract fraudulent information from a historical fraudulent data repository (not shown in figure) or the anomaly detecting unit (311) may be pre-configured to detect anomaly according to specific information of the plurality of entities (101₁, 101₂, . . . , 101_{N}). Based on the extracted information from the historical fraudulent data repository, the anomaly detecting unit (311) may be configured to flag the transactions that are fraudulent based on the previous fraudulent information extracted from the historical fraudulent data repository. Further, the anomaly-detecting unit (311) may be configured to send the flagged information to subsequent modules to generate the IOFT data elements.

In an embodiment, the pattern generating unit (312) may be configured to extract the transaction related information from the transaction data repository. Further, the pattern-generating unit (312) may be configured to identify one or more patterns in the plurality of fraudulent transactions by analysing the extracted transaction related information. In an embodiment, the one or more patterns are grouped according to the identified one or more patterns. In an embodiment, the one or more patterns may be identified using user inputs. For example, an expert may provide inputs regarding the data related to the plurality of fraudulent transactions. Further, the pattern generating unit (312) may use the user inputs to identify patterns of such data. The grouped one or more patterns forms the pattern data (307). Further, the pattern-generating unit (312) is configured to send the pattern data (307) to the filtering unit (209). In some embodiments, the pattern generating unit (312) may implement Artificial Intelligence (AI) techniques to identify the one or more patterns. For example, clustering techniques may be used to identify the one or more patterns. In another example, pattern matching techniques may be used.

In an embodiment, the IOFT definition generating unit (208) may generate the IOFT metadata (308) based on the pattern data (307) and the anomalies identified in the flagged information.

The IOFT definition generating unit (208) may be configured to receive filtered data. Further, the IOFT definition generating unit (208) may be configured to generate IOFT metadata definitions using predefined mechanism for generating data definition structures from the filtered data elements. In an embodiment, the predefined mechanism may be used to map the input list of parameters against a list of all data elements that are available in transaction data repository and its corresponding data definitions. Once a match is identified for all the parameters associated with a common set of fraudulent transactions, then a data definition structure may be generated using the data definition of the individual data elements appended with specific parameters.

In an embodiment, the consent management unit (314) may be configured to check for consent from the plurality of entities (101₁, 101₂, . . . , 101_{N}) to share respective plurality of fraudulent transactions with other entities in the trusted network (100). Only the data for which consent is available may be shared with other entities. Further, the consent management unit (314) may send the data for which consent is provided to the filtering unit (209).

In an embodiment, the filtering unit (209) unit may receive the pattern data (307) from the pattern-generating unit (312). The filtering unit (209) may also receive the flagged information from the anomaly-detecting unit (311). The filtering unit (209) may filter out the confidential data elements from the IOFT metadata. After receiving the information from the anomaly detecting unit (311), the pattern generating unit (312) and the confidential data unit (313), the filtering unit (209) may use the pattern data (307) and the data received from the confidential data unit (313) and filter the confidential data from the flagged fraudulent transactions. Further, the filtered data or the finalized IOFT data set may be provided to the IOFT definition generating unit (208). In an exemplary embodiment, the filtering unit (209) may implement zero-knowledge proof technique to filter the confidential data. A person skilled in the art should appreciate that other filtering techniques may be used, and the scope of the present disclosure is not limited to zero-knowledge proof technique. In an embodiment, the filtering unit (209) may perform data comparison and data extraction processes to generate finalized IOFT data set. The data comparison may be performed against predefined set of data elements identified by the plurality of entities (101₁, 101₂, . . . , 101_{N}) as data elements that should not be included in the IOFT data for sharing with the other entities. The data extraction mechanism may check the IOFT data elements for presence of any predefined set of data elements. If the predefined set of data elements is present, then the IOFT data elements may be extracted from the input IOFT data element list and may be packaged into a new IOFT element data set. The new IOFT element data set obtained is referred as finalized IOFT data set.

In an embodiment, the IOFT composing unit (315) may be configured to receive the IOFT metadata definitions from the IOFT definition-generating unit (208). Further, the IOFT composing unit (315) may receive consolidated transactional data elements from the filtering unit (209). The IOFT composing unit (315) may provide flagged fraudulent transaction data and may extract the IOFT metada definitions from OFT metadata data repository for generating the IOFT data set. The IOFT composing unit (315) may employ basic data translation mechanism, where by the flagged fraudulent transaction data may be translated into IOFT elements using the IOFT metadata definitions as the core mapping reference for the translation.

In an embodiment, the IOFT DID generating unit (207) may be configured to receive the finalized IOFT data elements from the IOFT filtering unit (209). The DID document generating unit (207) may be responsible for converting the finalized IOFT data set which is devoid of confidential data elements into an encrypted format that may be compliant with the DID standards. The generated document may be sent to IOFT DID data repository and after validation by the trusted network (100), the DID associated with the DID document may be lodged in a local copy block-chain ledger (205). The DID document may be managed using Public Key Infrastructure (PKI) keys of the plurality of entities (101₁, 101₂, . . . , 101_{N}) involved in sharing of the DID document.

In an embodiment, the other modules may refer to transaction data repository, historical fraudulent transaction repository or any other module used by the computing system (301) for performing the method.

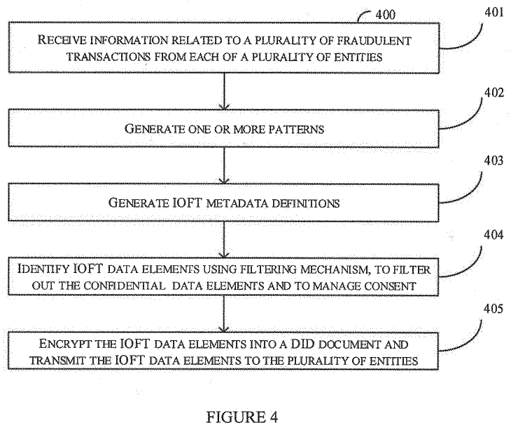

FIG. 4 shows an exemplary flow chart illustrating method steps (400) for preventing the fraud in the trusted network (100).

The order in which the method (400) is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step (401), receiving by the computing system (301) the information related to the plurality of fraudulent transactions from each of the plurality of entities (101₁, 101₂, . . . , 101_{N}) in the trusted network (100). The anomaly detecting unit (311) may extract the fraudulent information from the historical fraudulent data repository. Based on the information related to the plurality of fraudulent transactions from each of the plurality of entities (101₁, 101₂, . . . , 101_{N}) and the historical fraudulent data repository, the anomaly detecting unit may flag the transactions that are fraudulent. The anomaly detecting unit (311) may be pre-configured according to specific information of the plurality of entities (101₁, 101₂, . . . , 101_{N}). In a first example, consider two medical research centres X and Y. The medical research centres X and Y may be working in conjunction to discover a drug for a disease Z. An employer E from the medical research centre X may misuse the drug by preparing a fake prescription and selling it for money. The selling of drug which is still under research and not tested yet may be dangerous to people using the drug. The medical research centre X may notice this fraud and may want to share information related to the fraud to other research centres so that the people are aware of the fraud. The anomalies may refer to the confidential elements of the medical research centre X which comprises the name of the drug, the composition of the drug and the like.

At step (402), receiving by the computing system unit (301) the pattern data (307). The pattern-generating unit (312) may generate one or more patterns by analysing the extracted transaction related information. In an embodiment, the generated one or more patterns may be grouped based on the definitions such as frequency of transactions from a specific IP within an IP range, frequency of transaction based on the modes of transactions, specific information of the plurality of entities (101₁, 101₂, . . . , 101_{N}), confidential data elements or the like. Further, the pattern-generating unit may send the grouped patterns to the filtering unit (209). The filtering unit (209) may filter out the confidential data elements from the IOFT metadata. Referring to the first example, the false prescription may comprise of names of patient on the prescription, details of the medical research centres X and Y, and the like. The pattern generation unit (312) may have received a plurality of data related to such false prescription having the above details. The pattern generation unit (312) may further identify patterns from the false prescription and may classify the patterns into at least one of names of patient, names of medical research centres, names of drugs, dosage of drugs, coarse of drug consumption and the like, fraud identified in the prescription, frequency of the identified fraud in the prescription and the like.

At step (403), generating by the computing system (301) the IOFT metadata (308). The IOFT definition generating unit (208) may generate the IOFT metadata (308) based on the generated patterns and the anomalies identified in the information. The IOFT metadata may comprise transaction details and the confidential details. Referring to the first example, the transaction details may be one of name of the drug, composition of the drug, status of the drug (under test), effects of consumption of the drug and the like. The confidential details may be details of the medical research centre X and Y, details of the patient and the like.

At step (404), identifying, by the computing system (301), one or more IOFT data elements comprising transaction details associated with the plurality of fraudulent transactions and excluding confidential details from the IOFT metadata (308). The confidential data unit (313) may check for presence of confidential data elements in the IOFT metadata. Also, the consent management unit (314) checks for consent from the plurality of entities (101₁, 101₂, . . . , 101_{N}) to share their data with other entities. After receiving the information from the anomaly detecting unit (311), the pattern generating unit (312) and the confidential data unit (313), the filtering unit (209) may use the pattern data (307) and the data received from the confidential data unit (313) and filter the confidential data from the flagged fraudulent transactions. Further, the filtered data or the finalized IOFT data set may be provided to the IOFT definition generating unit (208). In an exemplary embodiment, the filtering unit (209) may implement zero-knowledge proof technique to filter the confidential data. In an embodiment, the filtering unit (209) may perform data comparison and data extraction processes to generate finalized IOFT data set. The data comparison may be performed against predefined set of data elements identified by the plurality of entities (101₁, 101₂, . . . , 101_{N}) as data elements that should not be included in the IOFT data for sharing with the other entities. The data extraction mechanism may check the IOFT data elements for presence of any predefined set of data elements. If the predefined set of data elements is present, then the IOFT data elements may be extracted from the input IOFT data element list and may be packaged into a new IOFT element data set. Referring to the example (400a), the confidential data unit (313) may identify the details of the medical research centre X and Y, details of the patient, details of the drug as the confidential data elements. The confidential data unit (313) may identify the confidential data elements by using a text classification algorithm, a content-based method, a behavior based method or the like. The consent management unit (314) may check for a signature of the medical research centre X.

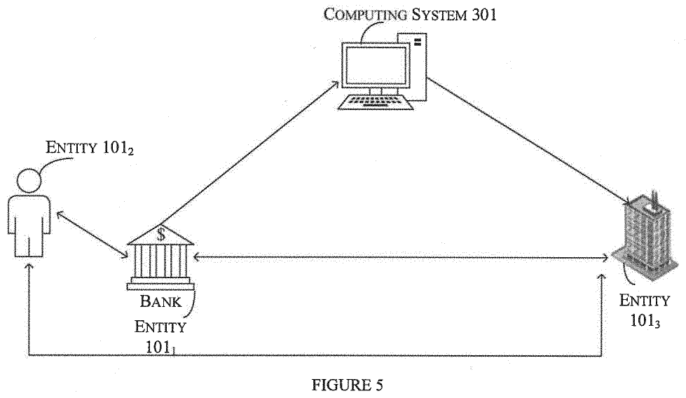

At step (405), generating by the IOFT DID Generating Unit (207) the encrypted IOFT data elements (309) in the form of IOFT DID Document. The generated document may be sent to IOFT DID data repository and post validation by the trusted network (100), the DID associated with the DID document may get lodged in the local copy block-chain ledger (205). The DID document may be accessed using private key of the plurality of entities (101₁, 101₂, . . . , 101_{N}) involved in sharing of the DID document. The plurality of entities (101₁, 101₂, . . . , 101_{N}) in the trusted network (100) may provide access to contents of the IOFT DID document by encrypting the IOFT DID document using a public key. The public key may be shared between each of the plurality of entities (101₁, 101₂, . . . , 101_{N}) in the trusted network (100). Each of the plurality of entities (101₁, 101₂, . . . , 101_{N}) may be enabled to access the contents of the IOFT DID document using respective private key. Referring to the example (400a), the DID document may comprise the transaction details to prevent the fraud without including any confidential information. The research centres on the trusted network (100) may access the DID document and may take necessary measures. FIG. 5 shows an exemplary environment illustrating prevention of the fraud between the plurality of entities (101₁, 101₂, . . . , 101_{N}) connected in the trusted network (100). In an example, entity (101₁) may refer to a bank, entity (101₂) may refer to a customer associated with the bank and entity (101₃) may refer to an insurance company. In the example, the customer (101₂) associated with the bank (101₁) may have undergone fraud. The bank (101₁) may desire to share this information related to the fraud, without including the confidential information related to the customer (101₂) with the insurance company (101₃), so that the insurance company (101₃) may take measures to prevent the fraud. In the example, the confidential information may refer to the personal information of the customer (101₂) and account details of the user. The transaction details may comprise the Amount debited, the mode of the transaction, the payment details associated with the transaction. The method step (401) may be performed to receive fraud information. The customer (101₂) associated with the bank (101₁) may provide the consent along with the fraud information. The method step (402) may be performed to detect anomaly and to generate patterns. The anomaly may be related to the private bank information of the customer (101₂). The generated patterns may be pattern of account details. The method step (403) may be performed to generate IOFT metadata by filtering, based on the patterns and the anomalies. The method step (404) may be performed to filter out confidential data elements and to manage consent. Clustering algorithm may be used to find confidential data elements by providing the algorithm with confidential keywords such as length of account number. The method step (405) may be followed to transmit the information related to the fraud associated with the customer (101₂) of the bank (101₁) to the insurance company (101₃).

### Computer System

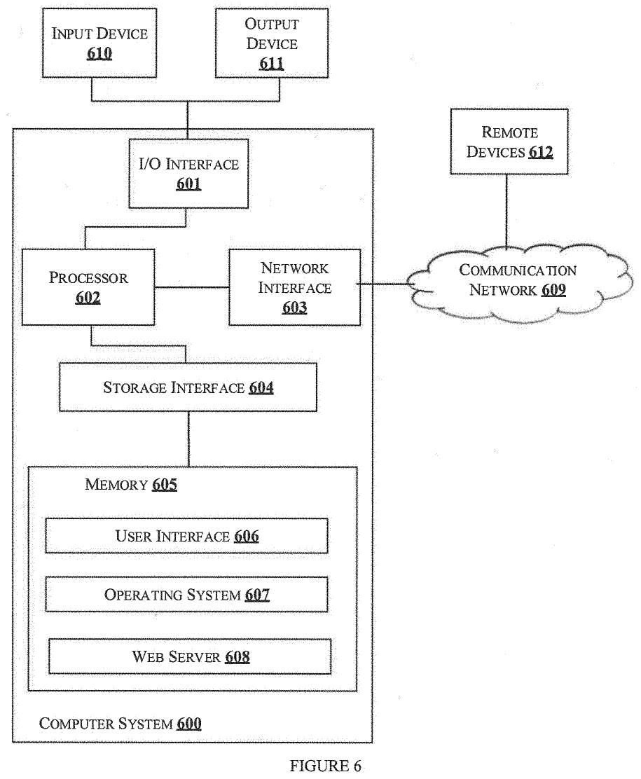

FIG. 6 illustrates a block diagram of an exemplary computer system (600) for implementing embodiments consistent with the present disclosure. In an embodiment, the computer system (600) is used to implement generation of sentiment-based summary for user reviews. The computer system (600) may comprise a central processing unit (“CPU” or “processor”) (602). The processor (602) may comprise at least one data processor. The processor (602) may include specialized processing units such as integrated system (bus) controllers, memory management control units, floating point units, graphics processing units, digital signal processing units, etc.

The processor (602) may be disposed in communication with one or more input/output (I/O) devices (not shown) via I/O interface (601). The I/O interface (601) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface (601), the computer system (600) may communicate with one or more I/O devices. For example, the input device (610) may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device (611) may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

In some embodiments, the computer system (600) is connected to the remote devices (612) through a communication network (609). The remote devices (612) may provide the user reviews to the computing network 600. The processor (602) may be disposed in communication with the communication network (609) via a network interface (603). The network interface (603) may communicate with the communication network (609). The network interface (603) may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network (609) may include, without limitation, a direct interconnection, local area network (LAN), wide area network (WAN), wireless network (e.g., using Wireless Application Protocol), the Internet, etc. Using the network interface (603) and the communication network (609), the computer system (600) may communicate with the scene remote devices (612). The network interface (603) may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network (609) includes, but is not limited to, a direct interconnection, an e-commerce network, a peer to peer (P2P) network, local area network (LAN), wide area network (WAN), wireless network (e.g., using Wireless Application Protocol), the Internet, Wi-Fi and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor (602) may be disposed in communication with a memory (605) (e.g., RAM, ROM, etc. not shown in FIG. 6) via a storage interface (604). The storage interface (604) may connect to memory (605) including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory (605) may store a collection of program or database components, including, without limitation, user interface (606), an operating system (607), web server (08) etc. In some embodiments, computer system (600) may store user/application data (606), such as, the data, variables, records, etc., as described in this disclosure. Such databases may be implemented as fault-tolerant, relational, scalable, secure databases such as Oracle® or Sybase®.

The operating system (607) may facilitate resource management and operation of the computer system (600). Examples of operating systems include, without limitation, APPLE MACINTOSHR OS X, UNIXR, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HATT™, UBUNTU™, KUBUNTU™, etc.), IB™ OS/2, MICROSOFT™ WINDOWS™ (XP™, VTSTA™/7/8, 10 etc.), APPLE® IOS™, GOOGLE® ANDROID™, BLACKBERRY® OS, or the like.

In some embodiments, the computer system (600) may implement a web browser (608) stored program component. The web browser (608) may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers (608) may utilize facilities such as AJAX™, DHTML™, ADOBE® FLASH™, JAVASCRIPT™, JAVA™, Application Programming Interfaces (APIs), etc. In some embodiments, the computer system (600) may implement a mail server stored program component. The mail server may be an Internet mail server such as Microsoft Exchange, or the like. The mail server may utilize facilities such as ASP™, ACTIVEX™, ANSI™ C++/C#, MICROSOFT®, .NET® CGI SCRIPTS®, JAVA™, JAVASCRIT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system (600) may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, CD ROMs, DVDs, flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 4 shows certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

None of the existing techniques provides a mechanism for generating and sharing indicators of fraudulent transactions (IOFTs) between multiple entities. The existing techniques does not provide a mechanism on ability of an entity or enterprise to determine if the information can be shared with others without compromising on confidential information in an encrypted format along with the consent from various stakeholders. In the existing techniques, there is no concept of a network where each entity is on boarded onto a network which is managed by entities in the network rather than any single entity.

The present disclosure may provide several advantages. IOFTs may be dynamically generated to be shared among the plurality of entities. The generated indicators may be shared with the plurality of entities without compromising on divulging confidential data. The information related to the fraud is shared, thus helps in preventing the fraud.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method for preventing fraud in a trusted network, the method comprising:
receiving, by a computing system, information related to a plurality of fraudulent transactions from each of a plurality of entities in the trusted network, wherein each of the plurality of entities provides a consent for sharing the information related to corresponding plurality of fraudulent transactions;
generating, by the computing system, Indicators of Fraudulent Transactions (IOFT) metadata based on one or more patterns in the information related to the plurality of fraudulent transactions;
identifying, by the computing system, one or more IOFT data elements from the IOFT metadata, wherein the one or more IOFT data elements comprise transaction details associated with the plurality of fraudulent transactions and excludes confidential details; and
transmitting, by the computing system, the one or more IOFT data elements in an encrypted format to the plurality of entities over the trusted network to prevent the fraud in the trusted network.

2. The method of claim 1, wherein the information related to the plurality of fraudulent transactions is received from an anomaly detecting unit configured to detect the plurality of fraudulent transactions from a plurality of transactions.

3. The method of claim 1, wherein generating the one or more patterns comprises:
analysing and grouping the information based on definitions comprising one or more of, frequency of transactions from a specific Internet Protocol (IP) within an IP range, frequency of transaction based on modes of transactions, information related to the plurality of entities, confidential data elements.

4. The method of claim 1, wherein the IOFT metadata comprises at least one of an Internet Protocol (IP), Media Access Control (MAC) address, Uniform Resource Locator (URL) associated with each of the plurality of transactions, data feed elements from one or more applications used for the transaction associated with the plurality of entities and mode of transactions; wherein the transaction details comprises at least one of details related to transactions made by the plurality of entities, details related to data transactions made by the plurality of entities, a mode of transactions used by the plurality of entities; and wherein the confidential information comprises one or more of personal information of the plurality of entities.

5. The method of claim 1, wherein identifying the IOFT data elements comprises performing checks for blacklist entity information, checks for confidential details and checks for consent to transmit the information over the trusted network.

6. The method of claim 1, wherein transmitting the IOFT data elements in an encrypted manner comprises:
converting the IOFT data elements into a Decentralized Identity (DID) Document, wherein the DID Document comprises IOFT data elements in the encrypted format compliant with DID standards; and
validating the IOFT DID document to manage the consent before transmitting over the trusted network.

7. The method of claim 1, wherein the plurality of entities in the trusted network is provided access to content of the IOFT DID document using Public Key Infrastructure (PKI).

8. The method of claim 1 wherein the IOFT DID document is transmitted to the plurality of entities in the trusted network over a peer-to-peer communication channel.

9. A system for preventing fraud in a trusted network, the system comprising:
a hardware processor; and
a memory, wherein the memory stores processor-executable instructions, which, on execution, cause the hardware processor to:
receive information related to a plurality of fraudulent transactions from each of a plurality of entities in the trusted network, wherein each of the plurality of entities provides a consent for sharing the information related to corresponding plurality of fraudulent transactions;
generate Indicators of Fraudulent Transactions (IOFT) metadata based on one or more patterns in the information related to the plurality of fraudulent transactions;
identify one or more IOFT data elements from the IOFT metadata, wherein the one or more IOFT data elements comprise transaction details associated with the plurality of fraudulent transactions and excludes confidential details; and
transmit the one or more IOFT data elements in an encrypted format to the plurality of entities over the trusted network to prevent the fraud in the trusted network.

10. The system of claim 7, wherein the processor receives information related to the plurality of fraudulent transactions from an anomaly detecting unit configured to detect the plurality of fraudulent transactions from a plurality of transactions, wherein the processor receives the information to generate the one or more patterns by:
analysing and grouping the information based on definitions comprising one or more of, frequency of transactions from a specific Internet Protocol (IP) within an IF range, frequency of transaction based on modes of transactions, information related to the plurality of entities, confidential data elements.

11. The system of claim 7, wherein the processor identifies the IOFT data elements by performing checks for blacklist entity information, checks for confidential details and checks for consent to transmit the information over the trusted network.

12. The system of claim 7, wherein the processor transmits the IOFT data elements in an encrypted manner by,
converting the IOFT data elements into a Decentralized Identity (DID) Document, wherein the DID Document comprises finalized IOFT data elements in the encrypted format compliant with DID standards.
validating the IOFT DID document to manage the consent before transmitting over the trusted network, wherein the IOFT DID document is transmitted to the plurality of entities in the trusted network.

13. The system of claim 7, wherein the plurality of entities in the trusted network is provided access to content of the IOFT DID document using Public Key Infrastructure (PKI).

14. The system of claim 7 wherein the IOFT DID document is transmitted to the plurality of entities in the trusted network over a peer-to-peer communication channel.

15. A non-transitory computer readable medium including instructions stored thereon that when processed by at least one processor cause a computing system to,
receive information related to a plurality of fraudulent transactions from each of a plurality of entities in the trusted network, wherein each of the plurality of entities provides a consent for sharing the information related to corresponding plurality of fraudulent transactions;
generate Indicators of Fraudulent Transactions (IOFT) metadata based on one or more patterns in the information related to the plurality of fraudulent transactions;
identify one or more IOFT data elements from the IOFT metadata, wherein the one or more IOFT data elements comprise transaction details associated with the plurality of fraudulent transactions and excludes confidential details; and
transmit the one or more IOFT data elements in an encrypted format to the plurality of entities over the trusted network to prevent the fraud in the trusted network.

16. The medium of claim 15, wherein the processor receives information related to the plurality of fraudulent transactions from an anomaly detecting unit configured to detect the plurality of fraudulent transactions from a plurality of transactions, wherein the processor receives the information to generate the one or more patterns by:
analysing and grouping the information based on definitions comprising one or more of frequency of transactions from a specific Internet Protocol (IP) within an IP range, frequency of transaction based on modes of transactions, information related to the plurality of entities, confidential data elements.

17. The medium of claim 15, wherein the processor identifies the IOFT data elements by performing checks for blacklist entity information, checks for confidential details and checks for consent to transmit the information over the trusted network.

18. The medium of claim 15, wherein the processor transmits the IOFT data elements in an encrypted manner by,
converting the IOFT data elements into a Decentralized Identity (DID) Document, wherein the DID Document comprises finalized IOFT data elements in the encrypted format compliant with DID standards.
validating the IOFT DID document to manage the consent before transmitting over the trusted network (100), wherein the IOFT DID document is transmitted to the plurality of entities (101₁, 101₂, . . . , 101_{N}) in the trusted network.

19. The medium of claim 15, wherein the plurality of entities in the trusted network is provided access to content of the IOFT DID document using Public Key Infrastructure (PKI).

20. The medium of claim 15 wherein the IOFT DID document is transmitted to the plurality of entities in the trusted network over a peer-to-peer communication channel.
